(19) United States
(12) Patent Application Publication
(10) Pub. No.: US 2007/0059397 A1
(43) Pub. Date: Mar. 15, 2007

(54) Actuator System for an Injection Molding System

(75) Inventor: Michael Goinski, Rodgau (DE)

Correspondence Address: BUTZEL LONG, STONERIDGE WEST, 41000 WOODWARD AVENUE, BLOOMFIELD HILLS, MI, 48304, US

(73) Assignee: INCOE CORPORATION, Troy, MI (US)

(21) Appl. No.: 11/530,077

(22) Filed: Sep. 8, 2006

(30) Foreign Application Priority Data
Sep. 9, 2005 (DE) 10 2005 042 850.9

(51) Int. Cl. A21C 11/00; B29C 45/00

(52) U.S. Cl. 425/557; 425/462

(57) ABSTRACT

A closed system for actuating an injector nozzle valve in an injection molding system includes an actuator having a supply line and a return line that is operable to move the injector nozzle valve between an open position and a closed position. The system includes a compressor having an outlet line and a return line, a return valve in fluid communication with the actuator and the compressor, and an accumulator in fluid communication with the compressor and the return valve. The return valve is operable to connect the compressor outlet line with the actuator supply line and the compressor return line with the actuator return line in a first position and the compressor outlet line with the actuator return line and the compressor return line with the actuator supply line in a second position in order to move the injector nozzle valve between the open and closed positions.

### BACKGROUND OF THE INVENTION

The present invention relates in general to injection molding systems and, in particular, to an actuator system for an injection molding system.

During injection, molten material is generally injected by an injection machine, either directly or through a manifold, into the cavity (injection mold). The area of the injection nozzle, to which is connected to the cavity and the plastic will be referred to here as the “gate”. In this gate area, the injection nozzle is inserted into a recessed area in the tool, while the front part of the gate area is sealed with the injection nozzle by means of a precision diametrical fit. The injection nozzle has a fluid connection with the manifold.

Needle valves are known for a clean, secure seal of the gate, without leaving excess gate vestige on the final molded part. With them, the gate is opened and closed by means of a needle valve by which the needle can be moved pneumatically, hydraulically or electrically. With pneumatic and hydraulic drive, the needle operates with the help of a piston-cylinder device with the piston is fastened to the end of the needle that is away from the tool.

In the case of pneumatic drive, the necessary compressed air is usually delivered from a central compressed air supply at the facility site. To prevent contamination and corrosion, this compressed air must be filtered and dried, and for lubrication of cylinders and return valves, it must be lightly oiled. As the piston operates, the cylinder chamber is charged with compressed air on one side of the piston. The air in the opposite chamber is released into the environment (the production facility) to prevent a pressure buildup in this chamber.

During production of medical technology products, for example, the aforementioned pneumatic operation of the needle valve can often not be used, due to the danger of the air escaping the cylinder contaminating the cleanroom in which production often takes place.

### SUMMARY OF THE INVENTION

The present invention concerns a closed loop system for actuating an injector nozzle valve in an injection molding system includes an actuator having a supply line and a return line that is operable to move the injector nozzle valve between an open position and a closed position. The system includes a compressor having an outlet line and a return line, a return valve in fluid communication with the actuator and the compressor, and an accumulator in fluid communication with the compressor and the return valve. The return valve is operable to connect the compressor outlet line with the actuator supply line and the compressor return line with the actuator return line in a first position and the compressor outlet line with the actuator return line and the compressor return line with the actuator supply line in a second position in order to move the injector nozzle valve between the open and closed positions.

The invention described below involves a pneumatic actuator for regulating the gate of a needle valve in an injection molding system.

The invention presented here is intended to develop a pneumatic actuator of the aforementioned type, which can be harmlessly used even in cleanrooms, whose construction is simple, and whose operation is cost-effective.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a partial cross-sectional schematic view of a closed actuator system in accordance with the present invention.

### DESCRIPTION OF THE PREFERRED EMBODIMENT

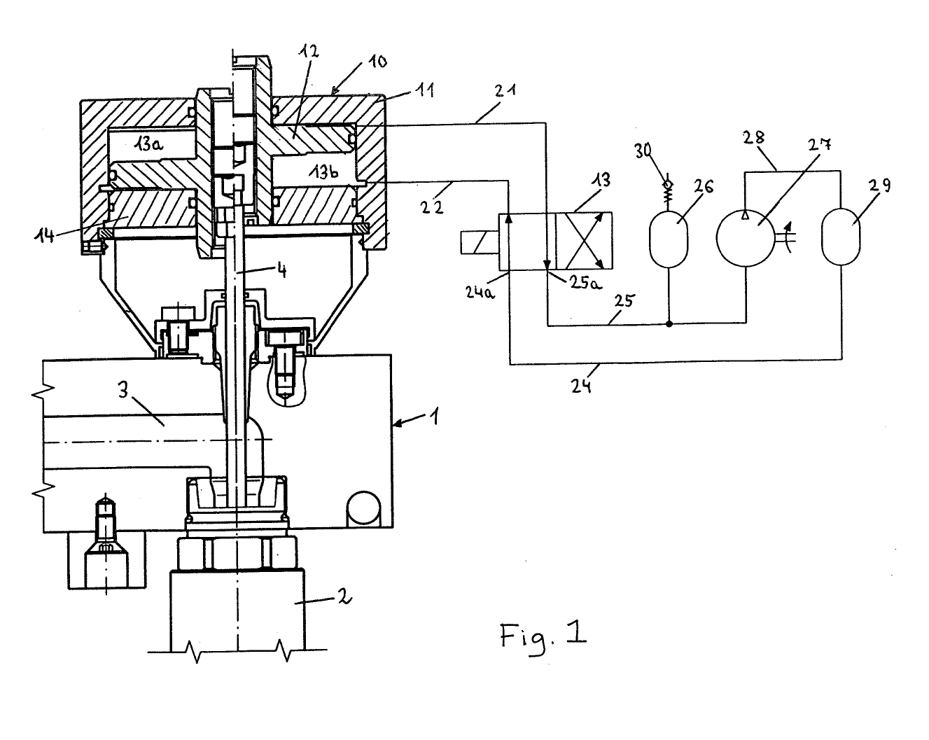

Referring now to FIG. 1, there is shown a part of the hot manifold block 1 and a melt channel 3 over which the molten plastic resin from the injection molding machine (not shown) is supplied to a nozzle 2. Only a part of the nozzle 2 is shown, i.e., the upper part which borders on the hot manifold block 1. The hot manifold system can contain more nozzles 2 that are connected to the remaining part of the hot manifold block 1 that is depicted in FIG. 1. In FIG. 1, a valve needle 4 leads upward out of the hot manifold block, and its upper end is attached to a piston 12 in a piston-cylinder device 10. The reference numeral 11 indicates the cylinder of the piston-cylinder device 10, and the reference numeral 14 indicates the cylinder cover. The operation of the needle valve 4, i.e., the opening and closing of the gate, occurs through the movement of the piston 1. This movement is driven by compressed air, which in FIG. 1 is supplied to either the upper cylinder chamber 13a or the lower cylinder chamber 13b. FIG. 1 shows the right and left of the vertical axis at the extreme position of the cylinder 12. The inlet apertures to both chambers 13a and 13b are connected by the lines 21 and 22 to a change-over or return valve 13.

The operation device used in this invention consists of two separate compressed air tanks, a pressure accumulator or tank 29 and a return accumulator or tank 26. The volume of the two accumulators or tanks 26 and 29 is adjusted both to each other and to the number of needle valves to be operated. Both tanks 26 and 29 are connected through a compressor 27 working atop the pressure tank 29. The exit side of the pressure tank 29 is connected by the line 24 to the compressed air supply port 24a of the return valve 13. The compressed air release port 25a of the return valve 13 is connected by the line 25 to the return tank 26 and the entry port of the compressor 27. The return tank 26 is connected to external air or atmosphere by a check valve 30. This check valve 30 can open itself automatically in the direction of the return tank 26, should a certain low pressure arise in regard to the surroundings.

If, during operation, the piston 12 reaches its other extreme position, compressed air is introduced from the pressure accumulator or tank 29 into the chamber currently free of compressed air 13b in the right portion of the illustration by the change-over or return valve 13, while the pressurized gas from the currently larger chamber 13a can flow out to the compressor 27 and/or the return accumulator or tank 26 through the line 21 and the return valve 13. Through the compressor 27, air is again compressed and directed through the line 28 to the pressure accumulator or tank 29. By reversal of the change-over or return valve 13, the switching operation of the piston-cylinder device 10 is set in the opposite direction.

With this invention, one thus obtains a closed system, by which, depending on the type of change-over valve 13, no air flow or very negligible air flow reaches the surrounding area. Air treatment, which is the current state of the art, is no longer necessary, because the same air circulates in the closed system all the time. If some air is lost from the system through leak defects, the valve 30 on the return tank 26 will draw replacement air from the atmosphere or environment.

Of course, the actuator device consisting of the units 26, 27 and 29 can be used for regulating several needle valves, especially all needle valves belonging to the manufacturing unit.

Assembly of the actuator is very simple, and involves merely connecting the compressor to a power supply, and the compressed air lines 24 and 25 to the return valves 13. The invention eliminates the danger of air contamination in cleanrooms, brings considerable cost savings, and results in less energy loss, because costly purification of contaminated ambient air is no longer necessary.

The actuator will, of course, also work with pressurized gas other than compressed air.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A system for actuating at least one injector nozzle valve in an injection molding system, comprising:
an actuator having a supply line and a return line, said actuator operable to move said at least one injector nozzle valve between an open position and a closed position;
a compressor having a high pressure fluid outlet line and a low pressure fluid return line;
at least one return valve in fluid communication with said actuator and said compressor, said valve having at least two positions, said at least one return valve operable to connect said compressor outlet line with said actuator supply line and said compressor return line with said actuator return line in a first position, said at least one return valve operable to connect said compressor outlet line with said actuator return line and said compressor return line with said actuator supply line in a second position in order to move said at least one injector nozzle valve between said open and closed positions; and
an accumulator in fluid communication with said compressor and said return valve.

2. The system according to claim 1 wherein said accumulator is in fluid communication with said high pressure fluid outlet line of said compressor and said return valve.

3. The system according to claim 2 including a second accumulator in fluid communication with said low pressure fluid return line of said compressor and said return valve.

4. The system according to claim 3 wherein a volume of each of said accumulators is adapted to each other and to said at least one injector nozzle valve.

5. The system according to claim 3 including a check valve in fluid communication with said second accumulator, said check valve operable to supply replacement fluid to said system.

6. The system according to claim 5 wherein said check valve is in fluid communication with atmosphere.

7. The system according to claim 1 wherein said actuator is a piston-cylinder device including a piston slidably disposed in a cylinder.

8. The system according to claim 7 wherein said actuator supply line is in fluid communication with a one side of said piston and said actuator return line is in fluid communication with another side of said piston.

9. The system according to claim 7 wherein said actuator includes a cylinder cover.

10. A system for actuating at least one injector nozzle valve in an injection molding system, comprising:
an actuator having a supply line and a return line, said actuator operable to move said at least one injector nozzle valve between an open position and a closed position;
a compressor having a high pressure fluid outlet line and a low pressure fluid return line;
at least one return valve in fluid communication with said actuator and said compressor, said valve having at least two positions, said at least one return valve operable to connect said compressor outlet line with said actuator supply line and said compressor return line with said actuator return line in a first position, said at least one return valve operable to connect said compressor outlet line with said actuator return line and said compressor return line with said actuator supply line in a second position in order to move said at least one injector nozzle valve between said open and closed positions; and
an accumulator in fluid communication with said high pressure fluid outlet line of said compressor and said return valve.

11. The system according to claim 10 including a second accumulator in fluid communication with said low pressure fluid return line of said compressor and said return valve.

12. The system according to claim 11 wherein a volume of each of said accumulators is adapted to each other and to said at least one injector nozzle valve.

13. The system according to claim 12 including a check valve in fluid communication with said second accumulator, said check valve operable to supply replacement fluid to said system.

14. The system according to claim 13 wherein said check valve is in fluid communication with atmosphere.

15. The system according to claim 10 wherein said actuator is a piston-cylinder device including a piston slidably disposed in a cylinder.

16. The system according to claim 15 wherein said actuator supply line is in fluid communication with a one side of said piston and said actuator return line is in fluid communication with another side of said piston.

17. The system according to claim 15 wherein said actuator includes a cylinder cover.

18. A closed loop system for actuating at least one injector nozzle valve in an injection molding system, comprising:
at least one piston-cylinder device having a piston slidably disposed in a cylinder, a supply line and a return line, said piston-cylinder device supply line in fluid communication with a one side of said piston and said piston-cylinder device return line in fluid communication with another side of said piston, said at least one piston-cylinder device operable to move said injector nozzle valve between an open position and a closed position;
a compressor having a high pressure fluid outlet line and a low pressure fluid return line;
at least one return valve in fluid communication with said at least one actuator and said compressor, said at least one return valve having at least two positions, said return valve operable to connect said compressor outlet line with said piston-cylinder device supply line and said compressor return line with said piston-cylinder device return line in a first position, said at least one return valve operable to connect said compressor outlet line with said piston-cylinder device return line and said compressor return line with said piston-cylinder device supply line in a second position in order to move said at least one injector nozzle valve between said open and closed positions;
a first accumulator in fluid communication with said high pressure fluid outlet line of said compressor and said at least one return valve; and
a second accumulator in fluid communication with said low pressure fluid return line of said compressor and said at least one return valve,
wherein a volume of each of said accumulators is adapted to each other and to said at least one injector nozzle valve, and
wherein said piston-cylinder device, said compressor, said return valve, and said accumulators form a closed actuating system

19. The system according to claim 18 including a check valve in fluid communication with said second accumulator, said check valve operable to supply makeup air to said system in the event of low system pressure.

20. The system according to claim 19 wherein said check valve is in fluid communication with atmosphere.
